(19) United States
(12) Patent Application Publication
(10) Pub. No.: US 2009/0175592 A1
(43) Pub. Date: Jul. 9, 2009

(54) INFORMATION RECORDING PROCESSING APPARATUS AND INFORMATION RECORDING PROCESSING METHOD

(75) Inventor: Shinya HARAGUCHI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/277,774

(22) Filed: Nov. 25, 2008

(30) Foreign Application Priority Data
Jan. 8, 2008 (JP) 2008-001303

(51) Int. Cl. H04N 5/91

(52) U.S. Cl. 386/95; 386/E05.003

(57) ABSTRACT

Disclosed herein is an information recording processing apparatus including: a connector configured to communicably connect a recording apparatus having a current date and time information counting function to the information recording processing apparatus; and a recording controller configured to control recording of an information signal by the recording apparatus connected to the information recording processing apparatus by the connector, forming of time stamp information based on current date and time information obtained from the recording apparatus, and recording of the time stamp information by the recording apparatus as information corresponding to an information signal to be recorded by the recording apparatus.

### CROSS REFERENCES TO RELATED APPLICATIONS

The present invention contains subject matter related to Japanese Patent Application JP 2008-001303 filed in the Japan Patent Office on Jan. 8, 2008, the entire contents of which being incorporated herein by reference.

### BACKGROUND OF THE INVENTION

1. Field of the Invention

The present invention relates to an information recording processing apparatus and an information recording processing method and, more particularly, to processing that is executed to record an information signal to a recording apparatus connected in a communicable manner.

2. Description of the Related Art

Patent Document 1: Japanese Patent Laid-Open No. 2006-148283

Patent Document 2: Japanese Patent Laid-Open No. 2006-242841

Many of recently developed AV (Audio Visual) devices, computer equipment, and other various electronic devices have clock features called a realtime clock that always counts current date and time information inside each device and uses the counted current date and time information for time display, information recording date and time, and information update date and time, for example.

### SUMMARY OF THE INVENTION

Assume here an information recording processing apparatus for example configured to record information to a connected recording apparatus. A recording apparatus herein denotes an apparatus on which a removable media for example can be loaded or an apparatus incorporating a recording media in a fixed manner. Mainly assumed herein are apparatuses such as a USB (Universal Serial Bus) memory containing a flush memory as a recording media and connectable to various types of devices by means of USB, for example. With such a recording apparatus connected, the information recording processing apparatus transfers a video signal, an audio signal, and other various kinds of signals to the recording apparatus to record these signals thereto.

For example, if an information recording processing apparatus such as mentioned above is assumed, having the information recording processing apparatus disposed with a realtime clock allows, in transferring information signals to a recording apparatus to record the transferred information signals thereto, the provision of recording time information (namely, current date and time information) about a file of the information signals to the recording apparatus to record this information thereto. Namely, the disposition of a realtime clock allows the attachment of the information about recording/update date to a file to be recorded to the recording apparatus side.

However, if the simplification of configuration or the cost reduction of manufacturing is required of this information recording processing apparatus, the disposition of the realtime clock feature sometimes presents an obstacle for this requirement. Disposition of the realtime clock feature on devices requires each user to execute time setting as an initial setting (immediately after purchase). Therefore, an operator key for timing setting and a display block on which numbers indicative of date and time can be displayed are always required. However, this is not desirable for devices for which the configuration for user interface must be minimized. Besides, once time setting has been executed, it is required to always execute time counting even if the power to device is in an off state, so that even devices that operate on AC (alternate current) power supply must incorporate a battery-based power supply system for time counting. Further, the disposition of the realtime clock feature requires the user to execute a cumbersome operation of time setting, which presents a disadvantage for devices that have to be easy in use.

Therefore, the present invention addresses the above-identified and other problems associated with related-art methods and apparatuses and solves the addressed problems by providing an information recording processing apparatus that can add a time stamp to an information signal to be recorded to a recording apparatus without disposing a realtime clock feature as an information recording processing apparatus configured to record information to a recording apparatus connected thereto.

In carrying out the invention and according to one embodiment thereof, there is provided an information recording processing apparatus. This information recording processing apparatus has connection means for communicably connecting a recording apparatus having a current date and time information counting function to the information recording processing apparatus; and recording control means for controlling recording of an information signal by the recording apparatus connected to the information recording processing apparatus by the connection means, forming of time stamp information based on current date and time information obtained from the recording apparatus, and recording of the time stamp information by the recording apparatus as information corresponding to an information signal to be recorded by the recording apparatus. This information recording processing apparatus further has signal input means in which an information signal is entered, wherein the recording control means records the information signal entered from the signal input means to the recording apparatus connected to the information recording processing apparatus by the connection means. In this information recording processing apparatus, the recording control means continues counting date and time by a counter on the basis of the current date and time information obtained from the recording apparatus to form the time stamp information from a count value of the counter with a predetermined timing of controlling recording of the information signal to the recording apparatus. Alternatively, the recording control means obtains the current date and time information from the recording apparatus with a predetermined timing of controlling recording of the information signal to the recording apparatus to form the time stamp information from the obtained current date and time information.

In the above-mentioned information recording processing apparatus, the signal input means is video input means for entering a video signal and the recording control means records to the recording apparatus the video signal entered from the video input means as the information signal. The signal input means is audio input means for entering an audio signal and the recording control means records to the recording apparatus the audio signal entered from the audio input means as the information signal. The above-mentioned information recording processing apparatus further has data compression means, wherein the recording control means records to the recording apparatus a compressed information signal compressed by the data compression means from an information signal entered from the signal input means. The recording control means selects an information signal recorded to the recording apparatus that is to be deleted on the basis of the time stamp information to delete the selected information signal from the recording apparatus. The connection means enables communication with a recording apparatus having a function of reproducing recorded information signal.

In carrying out the invention and according to another embodiment thereof, there is provided an information recording processing method. This information recording processing method has steps of recording an information signal to a communicably connected recording apparatus having a function of counting current date and time information; forming time stamp information on the basis of current date and time information obtained from the recording apparatus; and recording the time stamp information to the recording apparatus as information corresponding to each recorded information signal.

The above-mentioned information recording processing apparatus is a device configured to record vide/audio information for example to a recording apparatus having a function of counting current date and time information. A specific recording control operation may be an operation of directly controlling the recording of an information signal to a recording media in the recording apparatus, namely, an operation of controlling transmission of an information signal and writing the transmitted information signal or an operation of only transmitting an information signal to the recording apparatus, the recording of the information signal being executed by the recording apparatus. Recording apparatuses having a function of counting current date and time information (namely, a realtime clock function) may include a music player and a video player, for example. In recording an information signal such as video/audio to the recording apparatus configured as described above, current date and time information can be obtained from the recording apparatus to generate time stamp information as recording date and time.

According to the embodiments of the present invention, the information recording processing apparatus can effectively use the function of counting the current date and time information on the side of the recording apparatus to form time stamp information and also record recording date and time information for the information signal to be recorded to the recording apparatus. This novel configuration makes it unnecessary for the information recording processing apparatus to have any date and time counting function, any user interface configuration for date and time counting and time setting, and any power supply for steady counting, thereby realizing a significant configurational simplification, cost: cutting, and user convenience.

### BRIEF DESCRIPTION OF THE DRAWINGS

FIG. 1 is a schematic diagram illustrating a state in which devices practiced as embodiments of the present invention are interconnected;

FIGS. 2A and 2B are schematic diagrams illustrating an AV recorder practiced as one embodiment of the invention;

FIG. 3 is a block diagram illustrating the AV recorder shown in FIGS. 2A and 2B;

FIG. 4 is a block diagram illustrating a portable player practiced as one embodiment of the invention;

FIGS. 5A, 5B and 5C are diagrams illustrating a file recording form practiced as one embodiment of the invention;

FIG. 6 is a flowchart indicative of processing example I at the time of recording practiced as one embodiment of the invention;

FIG. 7 is a flowchart indicative of processing example II at the time of recording practiced as one embodiment of the invention; and

FIG. 8 is a flowchart indicative of delete processing practiced as one embodiment of the invention.

### DETAILED DESCRIPTION OF THE PREFERRED EMBODIMENTS

This invention will be described in further detail by way of embodiments thereof with reference to the accompanying drawings. For one embodiment of the invention, an AV (Audio Visual) recorder 1 as an example of an information recording processing apparatus according to the invention. For an example of a recording apparatus that is connected to the AV recorder 1, a portable player 50 is provided. The description will be made in the following order:

1. Configuration of the AV recorder

2. Configuration of the portable player

3. Processing example I at the time of recording

4. Processing example II at the time of recording

5. Example of delete processing

6. Effects of embodiments and variations

1. Configuration of the AV Recorder

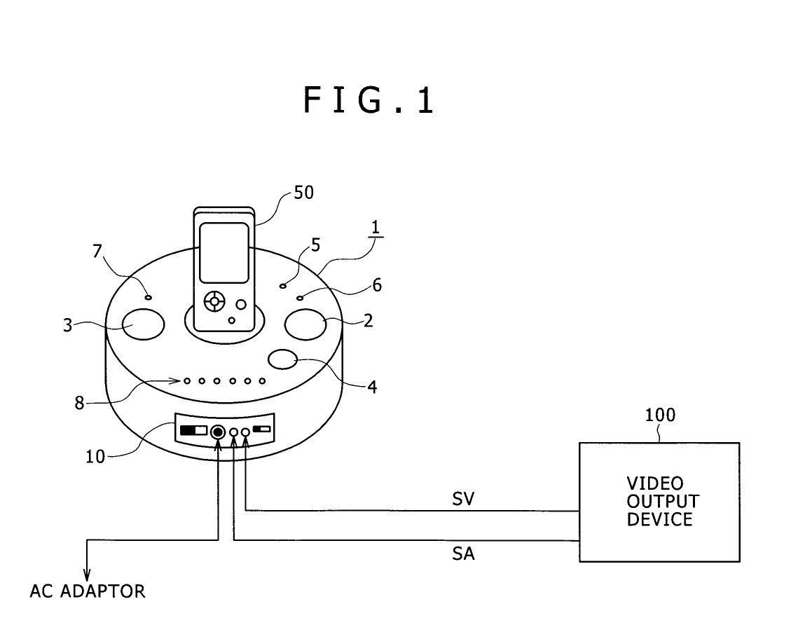

Now, referring to FIG. 1, there is shown a use form of the AV recorder 1 practiced as one embodiment of the invention. The AV recorder 1 has a cylindrical form shown for example, on which the portable player 50 can be loaded on top of the AV recorder 1. The portable player 50 is a portable audio/video player and configured to reproduce a music content file and a video content file recorded in a nonvolatile memory (a flash memory or a HDD (Hard Disk Drive) for example) incorporated in the portable player 50.

The AV recorder 1 of the present embodiment is configured to function as a battery charger for the portable player 50 and, at the same time, record music and video based on video signal SV and audio signal SA supplied from an external video output device 100 to the flash memory of the portable player 50 as a content file. Namely, the AV recorder 1 is a device configured to record a music content file and a video content file to the portable player 50 without user's having to use a personal computer for example.

In this example, it is assumed that the video signal SV and the audio signal SA be an analog video signal and L and R stereo analog audio signals, respectively. Namely, the video output device 100 as referenced herein is indicative of a device configured to output an analog video signal and an analog audio signal; a video reproducing machine, a television tuner, or a video camera, for example. It should be noted that the video output device 100 may also be an audio reproducing machine, a radio tuner, or a microphone device that is configured to output only an audio signal or a device that is configured to output only a video signal, for example.

When line-connected to the video output device 100, the AV recorder 1 can convert video signal SV and audio signal SA supplied from the video output device 100 into a digital file and record this digital file to the portable player 50 as a video content file (a moving image file for example). It should be noted that, when only an audio signal SA is supplied, the AV recorder 1 can convert the supplied audio signal SA into a digital data file to record this digital data file to the portable player 50 as a music content file. In addition, when only video signal SV is supplied, the AV recorder 1 can convert the video signal SV into a digital data file to record this digital data file to the portable player 50 as a video content file (still image content for example).

It should be noted that, in the present embodiment, the AV recorder 1 is described with video signal SV and an audio signal SA corresponding to analog signal input; however, it is also practicable to make video and audio signals correspond to digital signal input to record content files based thereon to the portable player 50.

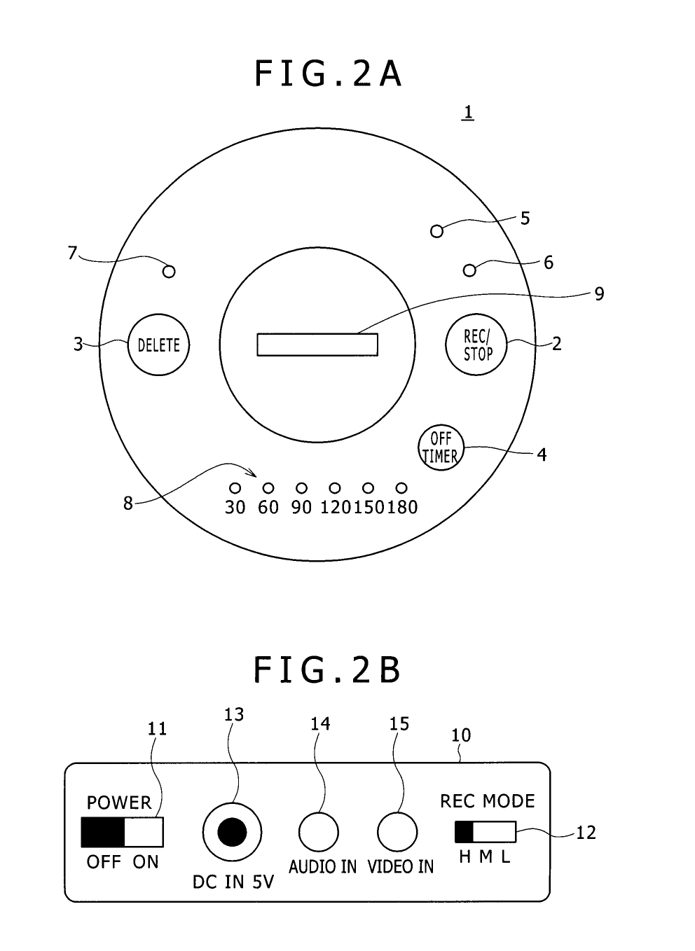

The AV recorder 1 has, on top thereof, various keys and a light emitting block. In addition, a side panel 10 is arranged on a side of the cylinder. FIG. 2A shows the top of the AV recorder 1. FIG. 2B shows the side panel 10. A connector 9 is arranged at the center of the top of the AV recorder 1. The connector 9 is connected with a connector of the portable player 50 to load the portable player 50 as shown in FIG. 1. A record/stop key 2, a delete key 3, and an off timer key 4 are arranged on top of the AV recorder 1 as operator keys. The record/stop key 2 is operated by the user to instruct the portable player 50 to start recording or stop recording. The delete key 3 is operated by the user to delete a content file from the portable player 50. The off timer key 4 is operated by the user to set a timer for automatically ending a recording operation.

For LEDs (Light Emitting Diodes) for display, a power display LED 5, a REC display LED 6, a delete display LED 7, and an off timer LED 8 are arranged. The power display LED 5 is indicative of a power-on state to the user by a light emitting operation. The REC display LED 6 is indicative of a recording-on state to the user by a light emitting operation. The delete display LED 7 is indicative of a delete-on state to the user by a light emitting operation. The off timer LED 8, made up of two or more LEDs corresponding to minutes for example, is indicative of a timer setting state and a timer-on state (namely, a remaining time) to the user by light emitting operations.

As shown in FIG. 2B, the side panel 10 is arranged with a power switch 11, a recording mode switch 12, a power terminal 13, an audio input terminal 14, and a video input terminal 15. The power switch 12 is a two-step slide switch to be operated by the user to turn on/off the power. The recording mode switch 12 is a three-stage slide switch for example and operated by the user for recording mode selection. For a recording mode, the bit rate of data to be recorded is selected, for example. The user can select, by operating the recording mode switch 12, the picture quality of a video content file to be recorded to the portable player 50 and the sound quality of an audio content file to be recorded to the portable player 50.

The power terminal 13 is a connection terminal of an AC adaptor, not shown. The AV recorder 1 of the present embodiment incorporates no battery and therefore operates on the direct power voltage supplied from an AC adaptor connected to a commercial alternate current power source. Through the audio input terminal 14, an audio signal SA is entered from the video output device 100. This audio input terminal 14 is a two-channel analog audio input terminal of L and R. Through the video input terminal 15, video signal SV is entered from the video output device 100. For example, a composite video signal is entered.

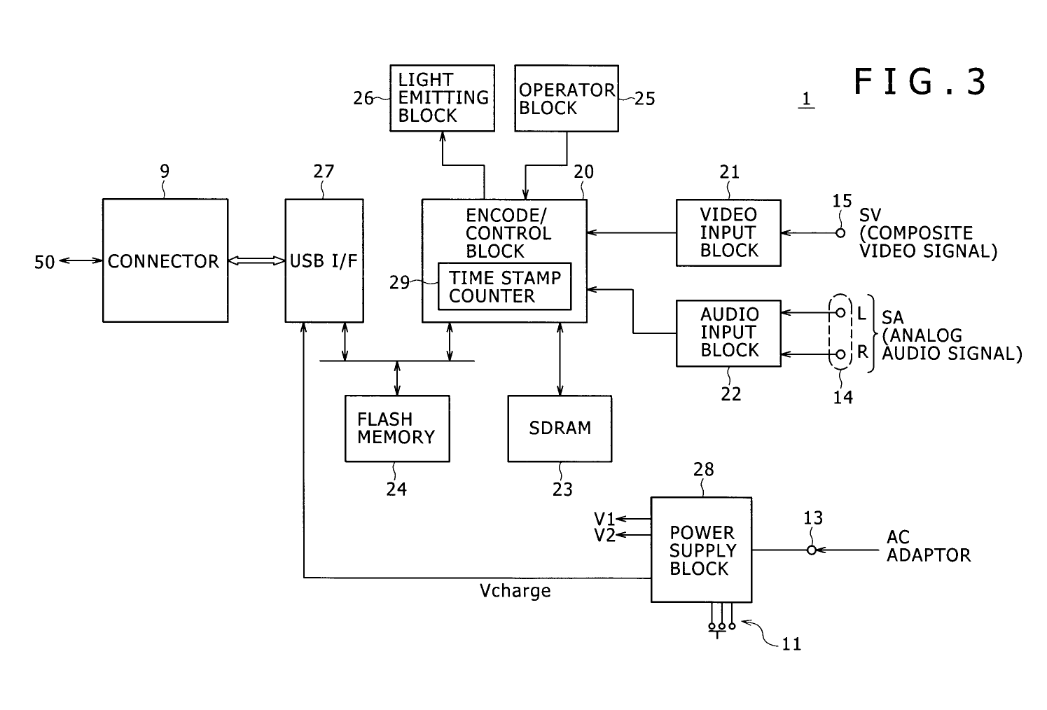

The following describes an internal configuration of the AV recorder 1 with reference to FIG. 3. An operator block 25 is comprehensively indicative of the above-mentioned record/stop key 2, delete key 3, off timer key 4, and recording mode switch 12 and a configuration of circuits for detecting operations of these controls. Namely, the operator block 25 is indicated as a member through which the user enters operations. Information about operations entered by the user through the operator block 25 is supplied to an encode/control block 20. A light emitting block 26 is comprehensively indicative of the above-mentioned power display LED 5, REC display LED 6, delete display LED 7, and off timer LED 8, and light emitting drive circuits for these LEDs. Each LED emits light under the control of the encode/control block 20.

A video input block 21 executes digitalization processing on video signal SV, a composite video signal for example, entered through the video input terminal 15 and supplies the digital signal to the encode/control block 20. An audio input block 22 executes digitalization processing on audio signal SA, analog audio signals SA of L arid R channels for example, entered through the audio input terminal 14 and supplies the digital signal to the encode/control block 20.

The encode/control block 20, made up of a microcomputer, controls the entire operation of the AV recorder 1 and, at the same time, executes encode processing on the entered video data and audio data. The encode/control block 20 encodes the video data and audio data supplied from the video input block 21 and the audio input block 22 into a predetermined format as a record content file to be recorded to the portable player 50. For example, data compression encoding of H.264/MPEG (Moving Picture Experts Group) 4 is executed on video data; data compression encoding of AAC-LC (Advanced Audio Coding—Low Complexity) is executed on audio data. It should be noted that, with the encode/control block 20, a bit rate (or compression rate) for compression encoding is selected by the user through the above-mentioned recording mode switch 12. Also, the encode/control block 20 executes control processing, such as recording processing and delete processing to be described later on the portable player 50, as instructed by the user through the operator block 25. Further, the encode/control block 20 controls the light emitting operation of each LED on the light emitting block 26 in accordance with operation states.

An SDRAM (Synchronous Dynamic Random Access Memory) 23 provides a work area for various computational processing operations to be executed by the encode/control block 20. A flash memory 24 is used to store programs necessary for the microcomputer that is the encode/control block 20 to execute processing, for example.

A USB interface 27 executes communication with the portable player 50 connected via the connector 9, on the basis of USB. In a standalone mode, the portable player 50 functions as a portable video/music reproducing machine; however, if the portable player 50 is connected to the AV recorder 1, the portable player 50 functions as a USB mass storage device with the AV recorder 1 being the host device. Namely, the encode/control block 20 of the AV recorder 1 can recognize the portable player 50 simply as a storage device (a device equivalent to a so-called USB memory) based on USB interface to access the nonvolatile memory (a flash memory 52 to be described later) by communication via the USB interface 27, thereby executing processing of recording and so on.

The power supply block 28 has a DC (direct current)/DC converter and generates various operating voltages V1, V2, and so on necessary for components by use of a direct current power supplied from an AC adaptor to the power terminal 13, supplying generated power voltages to the components. The power supply block 28 is configured to also generate a charge voltage Vcharge for the portable player 50 and supply the generated charge voltage to the portable player 50 connected via the USB interface 27 and the connector 9. It should be noted that the power supply block 28 turns on/off the power voltage supply to each component in accordance with the operation of the power switch 11.

In the example shown in FIG. 3, a time stamp counter 29 is disposed as an internal counter of the encode/control block 20, for example. Current date and time information is set to the time stamp counter 29 at the time of recording processing and then the time stamp counter 29 starts a date and time count operation, which will be described later. It should be noted that this time stamp counter 29 may or may not be disposed. Processing example I at the time of recording to be described later corresponds to a configuration in which this time stamp counter 29 is disposed. On the other hand, processing example II at the time of recording corresponds to a configuration in which the time stamp counter 29 is not disposed.

2. Configuration of the Portable Player

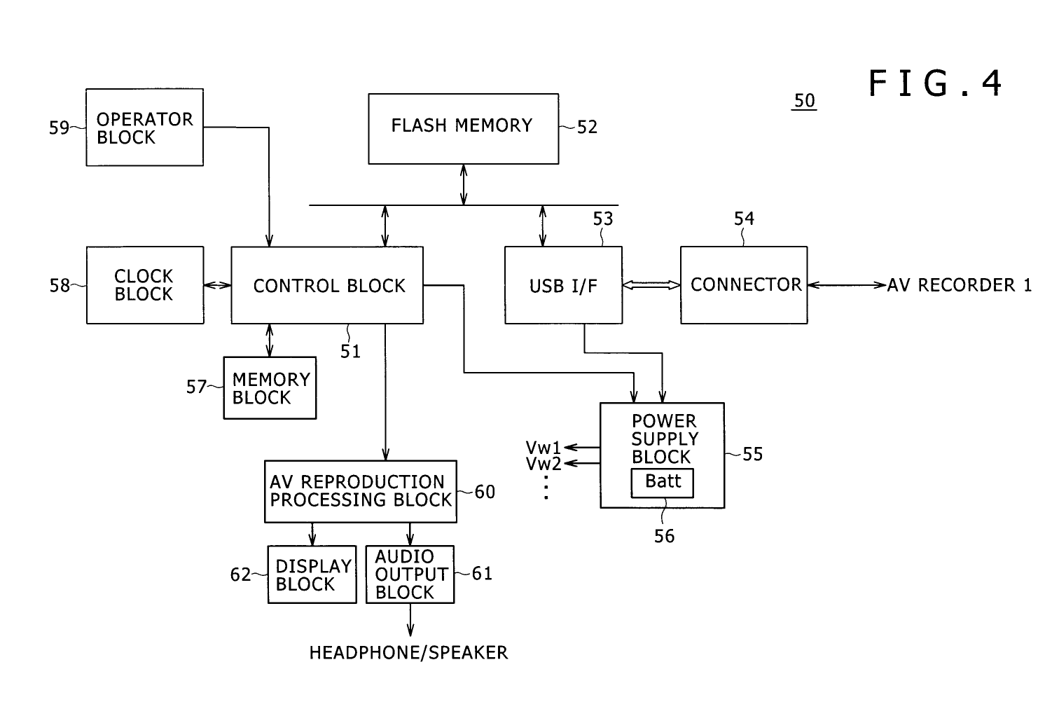

The following describes a configuration of the portable player 50 that is connected to the AV recorder 1 for content file recording and so on. Referring to FIG. 4, there is shown an internal configuration of the portable player 50.

The portable player 50 has a flash memory 52 as a nonvolatile memory that stores an audio content file, a video content file, and various management files, for example. The portable player 50 can reproduce content files stored in this flash memory 52. It should be noted that, instead of the flash memory 52, another nonvolatile recording media device, such as a HDD, may be installed.

An operator block 59 has controls for the user to execute various operations. If the portable player 50 is removed from the AV recorder 1 for use as a player, the user operates the operator block 59 to execute various operations, such as content reproduction, stop, and content selection. The information about operations done through the operator block 59 is supplied to a control block 51.

The control block 51, made up of a microcomputer, controls the portable player 50 in the entirety thereof. For example, in accordance with the operator information supplied from the operator block 59, the control block 51 controls the reproduction of video and music content files stored in the flash memory 52. A memory block 57 is comprehensively indicative of the ROM (read-only memory) or flash memory for storing processing programs to be executed by the control block 51 and the RAM (random access memory) providing a work area for use by the control block 51. A clock block 58 always counts current date and time (year, month, day, hour, minute, and second) as a so-called realtime clock. By confirming a count value of the clock block 58, the control block 51 can get the current date and time information to display the obtained current date and time information on a display block 62 for example.

An AV reproduction processing block 60 decodes video content data and audio content data at the time of reproducing a content file recorded to the flash memory 52 to generate video data to be displayed and audio data to be sounded. A display block 62, made up of a display panel based on a liquid crystal panel or an organic EL (Electroluminescence) panel for example and a display drive circuit, displays video signals supplied from the AV reproduction processing block 60. An audio output block 61, made up of a D/A converter and a power amplifier section for example, converts an audio signal decoded by the AV reproduction processing block 60 into an analog signal and amplifies the signal, outputting the amplified signal from a headphone or a loudspeaker connected to the portable player 50.

In reproducing a video content file recorded to the flash memory 52, the control block 51 reads the video content file from the flash memory 52 and transfers the video content file to the AV reproduction processing block 60 for decode processing. The decoded video data is supplied to the display block 62 to be displayed and the decoded audio data is outputted by the audio output block 61 from a headphone or a loudspeaker. This operation allows the user to view and hear video content and audio content.

A USB interface 53 executes USB-based communication with external devices connected through a connector 54. Each external device communicably connected by these USB interface 53 and connector 54 recognizes the portable player 50 as a USB mass storage device and is capable of accessing the flash memory 52.

In the present example, when the portable player 50 is loaded on the AV recorder 1 as shown in FIG. 1, the connector 54 gets connected to the connector 9 of the AV recorder 1. In this state, the USB interface 53 and the USB interface 27 of the AV recorder 1 become communicable with each other on an USB basis, making the encode/control block 20 of the AV recorder 1 ready for accessing the flash memory 52 of the portable player 50 as an external storage device.

Also, the communication via the USB interface 27 and the USB interface 53 allows the encode/control block 20 of the AV recorder 1 to transmit commands to the control block 51 of the portable player 50, thereby obtaining required information. In this example, especially the encode/control block 20 is configured to issue a command for requesting the control block 51 for current date and time information. Receiving this command, the control block 51 gets the current date and time information counted by the clock block 58 and transmits the obtained current date and time information to the encode/control block 20.

A power supply block 55 generates various operating power voltages Vw1, Vw2, and so on necessary for components by a DC/DC converter from the power of an incorporated battery 56 and supplies the generated power voltages to the components. The battery 56 is a secondary battery and, while the portable player 50 is loaded on the AV recorder 1, is supplied with a charge current from the AV recorder 1 for charging.

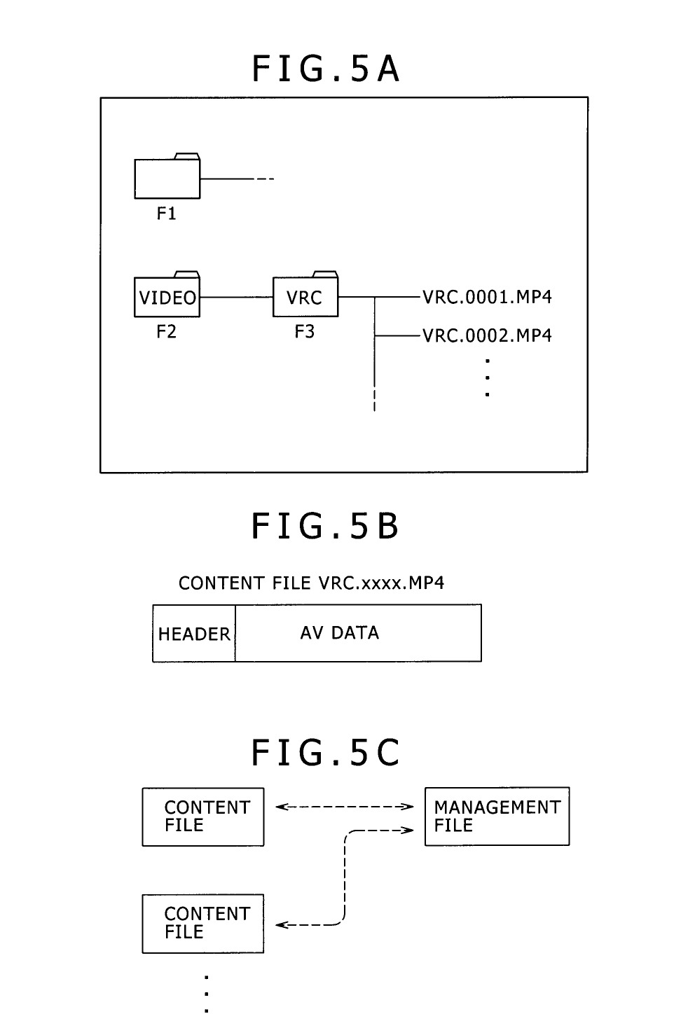

As described above, content files based on the video signal SV/audio signal SA supplied from the video output device 100 can be recorded by the AV recorder 1 to the flash memory 52 of the portable player 50. In this case, the files to be recorded to the flash memory 52 by the AV recorder 1 are as shown in FIGS. 5A through 5C. In FIG. 5A, folder F1 is a folder that stores, by the portable player 50, content files transferred from a personal computer for example. On the other hand, folder F2 is a folder that stores content files written by the AV recorder 1. For example, folder F3 is created in folder F2 and content files “VRC.0001.MP4,” “VRC.0002.MP4,” and so on are recorded into folder F3. In writing content files, if there are folders F2 and F3, the AV recorder 1 writes content files as files in folder F3. If there is no folders F2 and F3 in the flash memory 52, the AV recorder 1 creates folders F2 and F3 and writes content files as files that are managed in folder F3.

Further, in writing content files into the flash memory 52 of the portable player 50, the AV recorder 1 records time stamp information as a date and time of recording. For example, if a content file is made up of a header and AV data (real data of video/audio) as shown in FIG. 5B, the file may be formatted so as to add a time stamp as header information or, as shown in FIG. 5C, a time stamp may be recorded as a separate file. In the case of FIG. 5C, the time stamp of each individual content file is recorded in a management file to be related with each content file inside the management file. In any case, the time stamp may only be related with corresponding content files inside the flash memory 52. Actually, however, FAT32 for example is used for a file system for managing files to be recorded to the flash memory 52. Therefore, the time stamps may be managed, by the file management based on FAT32 for example, as the data and time of recording for the content files recorded by the AV recorder 1.

3. Processing Example I at the Time of Recording

The following describes processing example I at the time of recording that is executed when the portable player 50 is loaded on the AV recorder 1 as shown in FIG. 1. In recording a content file to the portable player 50 by use of the AV recorder 1, the user loads the portable player 50 on the AV recorder 1 and put the AV recorder 1 into a state where video signal SV and audio signal SA are supplied from the video output device 100 to the video input terminal 15 and the audio input terminal 14, respectively, of the AV recorder 1. Next, the user presses the record/stop key 2 at a desired time. Then, the AV recorder 1 starts encoding video signal SV and audio signal SA subsequently supplied from the video output device 100 and records the encoded signals to the flash memory 52 of the portable player 50 as a content file. Namely, by use of the AV recorder 1, the user records the video/audio signals outputted from the video output device 100 to the portable player 50 to later reproduce the recorded video/audio signals.

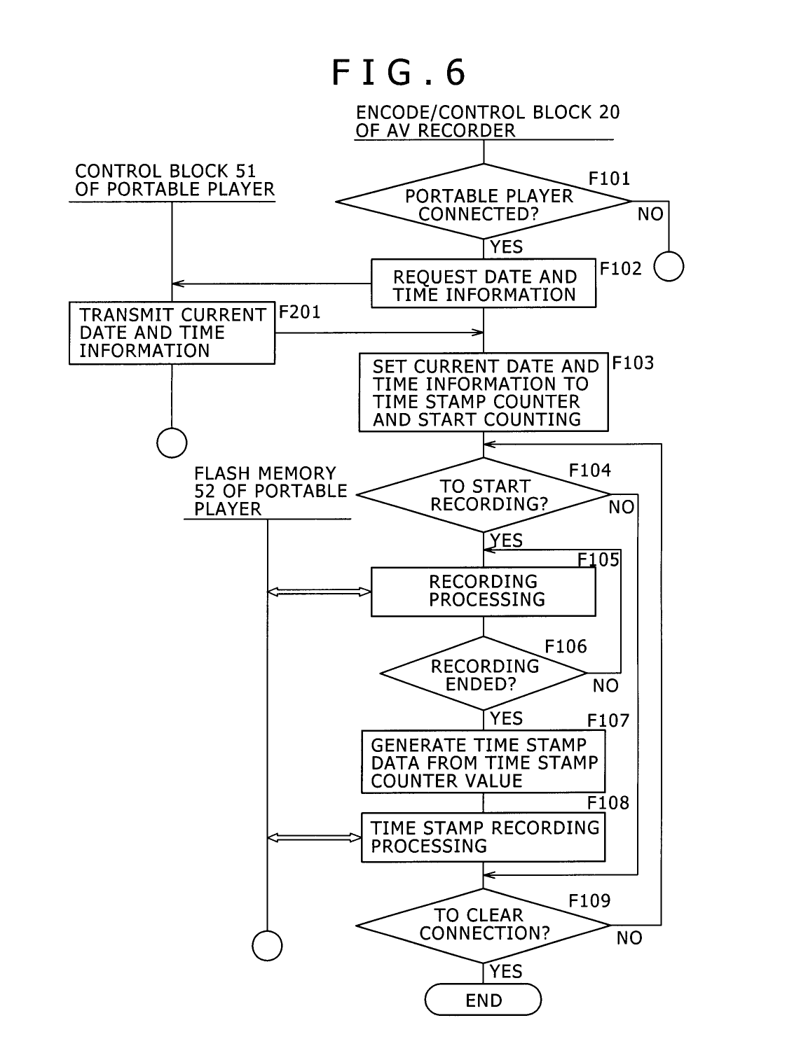

Referring to FIG. 6, there is shown the processing for the AV recorder 1 to execute the above-mentioned recording operation. In FIG. 6, the processing by the encode/control block 20 of the AV recorder 1 is indicated by steps F101 through F109.

First, in step F101, the encode/control block 20 determines whether the portable player 50 is connected or not. If the portable player 50 is connected to the AV recorder 1 and the initial connection processing (or configuration) of USB communication is executed to establish USB connection, then the processing of the encode/control block 20 goes from step F101 to step F102.

In step F102, the encode/control block 20 transmits a command for date and time information request to the control block 51 of the portable player 50. In response, the control block 51 of the portable player 50 reads the current date and time information counted by the clock block 58 and transmits the current date and time information to the encode/control block 20 in step F201. Receiving the current date and time information from the portable player 50, the encode/control block 20 sets the received current date and time information to the time stamp counter 29 in step F103, thereby starting the counting from the value of the set year, month, day, hour, minute, and second. Therefore, subsequently, the time stamp counter 29 functions as the realtime counter.

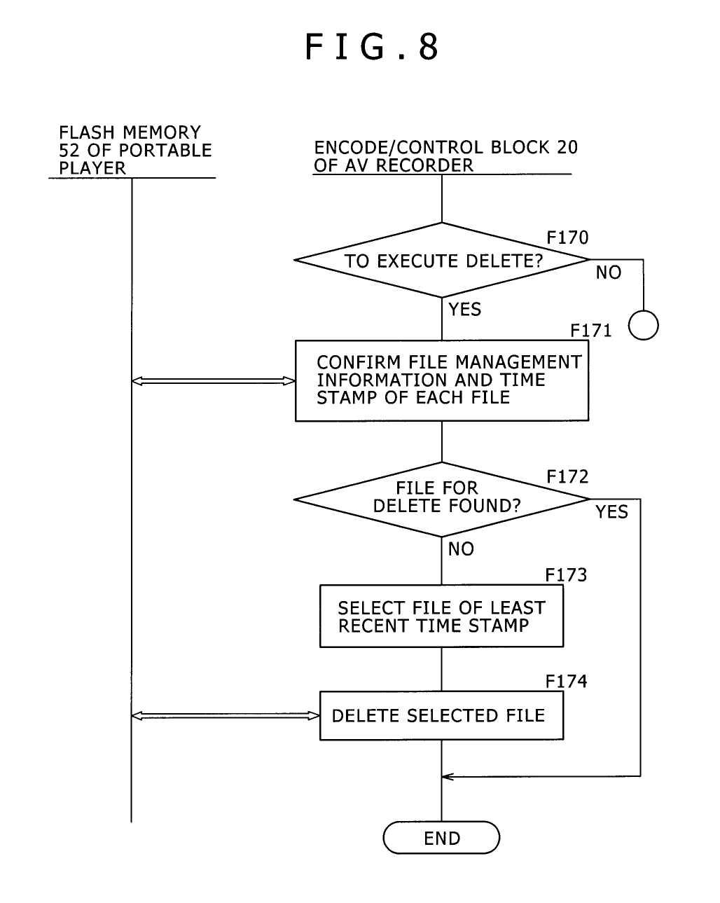

In step F104, the encode/control block 20 monitors whether the record/stop key 2 has been operated by the user. If the record/stop key 2 is found not operated, then the encode/control block 20 monitors whether the portable player 50 has been detached in step F109. It should be noted that the processing to be executed when the user operates the delete key 3 during a period in which the portable player 50 is loaded on the AV recorder 1 will be described later with reference to FIG. 8. Although the detail description of the processing to be executed when the off timer key 4 is pressed is skipped, the encode/control block 20 executes timer setting when to end recording after the start of recording in minutes in accordance with the number of times the off timer key 4 has been pressed.

If the pressing of the record/stop key 2 by the user is detected in step F104, the processing of the encode/control block 20 goes from step F104 to step F105. In step F105, the processing of recording a content file to the flash memory 52 of the portable player 50 is executed. To be more specific, the encode/control block 20 checks the file system of the flash memory 52. In addition, the encode/control block 20 makes the REC display LED 6 execute a light emitting operation. Next, the encode/control block 20 starts the encode processing of the video data/audio data supplied from the video input block 21 and the audio input block 22 and the write access processing of recording the content file data obtained by the encoding to the flash memory 52 of the portable player 50. The recording processing of step F105 is continued until the end of recording is determined in step F106. Consequently, the composite video signal and the analog audio signal supplied from the video output device 100 are encoded to be recorded to the portable player 50.

In step F106, the encode/control block 20 determines whether the recording is ended or not. If the record/stop key 2 is found pressed again by the user, the encode/control block 20 determines the end of recording. If the expiration of time set by the off timer is found without pressing of the record/stop key 2, the encode/control block 20 also determines the end of recording. Further, if the free space of the flash memory 52 has lowered equal to or below a predetermined level, the encode/control block 20 determines the end of recording.

If the end of recording has been determined, the encode/control block 20 ends the recording processing of step F105 and the processing goes to F107, in which the encode/control block 20 takes out the value of the time stamp counter 29 of that moment to generate time stamp data. Next, in step F108, the encode/control block 20 executes the processing of time stamp recording to the flash memory 52. For example, the time stamp is recorded so as to be managed in a predetermined management file as corresponding to the content file recorded this time. Then, the processing of the encode/control block 20 returns to the monitor processing of step F109 or step F104.

Then, when the record/stop key 2 is pressed, the encode/control block 20 executes the processing of step F105 through step F108 again. It should be noted that, although not shown in FIG. 6, if no input signal comes from the video output device 100 when the record/stop key 2 has been pressed by the user, error handling is executed. If the detachment of the portable player 50 is detected in step F109, the encode/control block 20 ends the processing shown in FIG. 6. Subsequently, if the portable player 50 is loaded again, the encode/control block 20 starts the processing from step F101.

In the AV recorder 1, the encode/control block 20 executes the above-mentioned control processing, thereby recording the video/audio data from the video output device 100 to the flash memory 52 of the portable player 50. At this moment, the portable player 50 functions only a USB mass storage, so that a time stamp must be recorded on the AV recorder side. According to the processing shown in FIG. 6, the time stamp counter 29 can be functioned as a realtime clock to allow the encode/control block 20 to get current date and time information. So, at the end of recording for example, the encode/control block 20 can generate time stamp data as the current date and time information to record the generated time stamp data to the flash memory 52 of the portable player 50. Namely, a time stamp can be attached to the recorded content file.

It should be noted that, in the example shown in FIG. 6, the date and time information at the time of recording end is the time stamp data; however, it is also practicable to read the date and time information at the time of recording start and the date and time information halfway in recording from the time stamp counter 29 to provide time stamp data and record this time stamp data as corresponding to a content file. The counting of the time stamp counter 29 may be continued from the start in step F103 up to the turn-off of the power. Alternatively, the counting of the time stamp counter 29 may be stopped upon detection of the detachment of the portable player 50 in step F109. Still alternatively, the counting of the time stamp counter 29 may be stopped upon the end of recording of one content file and the end of the processing of step F108. In this case, however, the processing (the time setting and count starting of the time stamp counter 29) indicated by steps F102 and F103 must be executed at the time when the processing goes to the recording processing of step F105 without clearing the connection. It is also possible to execute the processing of steps F102 and F103 always at the time when the processing of the encode/control block 20 goes to step F105.

4. Processing Example II at the Time of Recording

The following describes processing example II at the time of recording. This processing example II is processing that can be executed if the AV recorder 1 does not have the time stamp counter 29. In this case, the same user operation as in processing example I is executed. Namely, in recording a content file to the portable player 50 by use of the AV recorder 1, the user loads the portable player 50 on the AV recorder 1 and puts the AV recorder 1 into a state where video signal SV and audio signal SA are supplied from the video output device 100 to the video input terminal 15 and the audio input terminal 14, respectively, of the AV recorder 1. Next, the user presses the record/stop key 2 at a desired time. Then, the AV recorder 1 starts encoding video signal SV and audio signal SA subsequently supplied from the video output device 100 and records the encoded signals to the flash memory 52 of the portable player 50 as a content file.

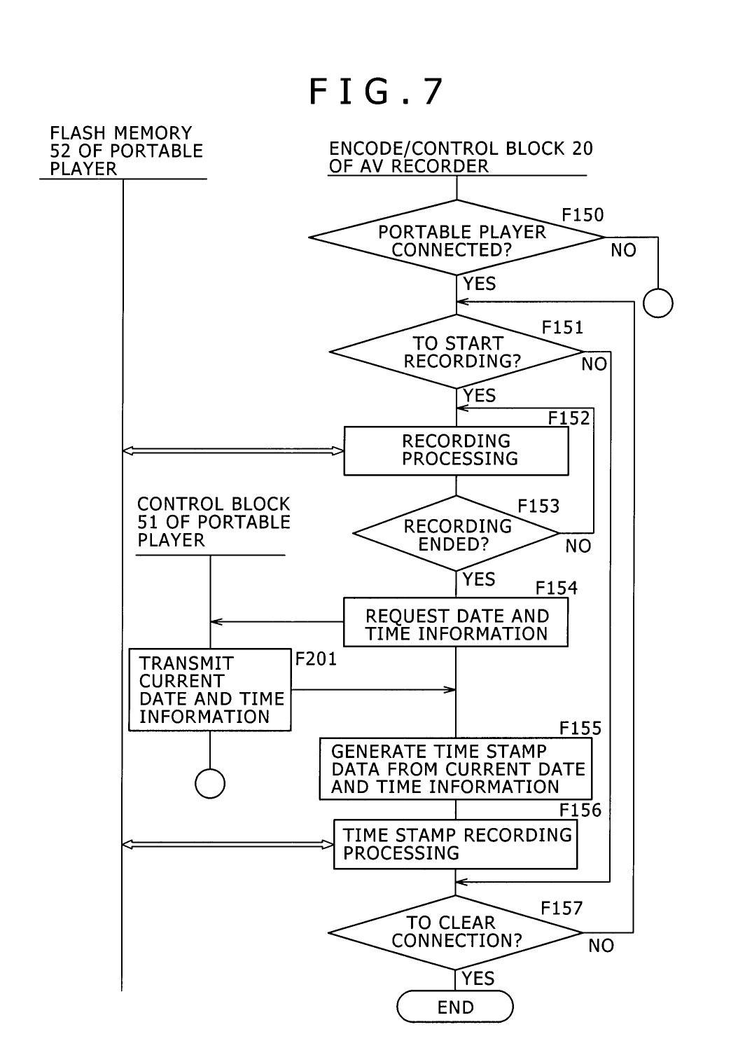

In FIG. 7, processing to be executed by the encode/control block 20 of the AV recorder 1 as processing example II is indicated by steps F150 through F157.

First, in step F150, the encode/control block 20 determines whether the portable player 50 is connected. If the portable player 50 is found connected to the AV recorder 1 as shown in FIG. 1 and the initial connection processing (or configuration) of USB communication is executed to establish USB connection, then the processing of the encode/control block 20 goes from step F150 to step F151.

In step F151, the encode/control block 20 monitors whether the record/stop key 2 has been operated by the user. If the record/stop key 2 is found not operated, then the encode/control block 20 monitors whether the portable player 50 has been detached in step F157. It should be noted that, also in FIG. 7, the description of the processing to be executed when the delete key 3 is operated by the user and the processing to be executed when the off timer key 4 is operated by the user are omitted.

If the record/stop key 2 is found pressed by the user in step F151, the processing of the encode/control block 20 goes from step F151 to step F152, in which the processing of recording a content file to the flash memory 52 of the portable player 50 is executed. To be more specific, the encode/control block 20 checks the file system of the flash memory 52. In addition, the encode/control block 20 makes the REC display LED 6 execute a light emitting operation. Next, the encode/control block 20 starts the encode processing of the video data/audio data supplied from the video input block 21 and the audio input block 22 and the write access processing of recording the content file data obtained by the encoding to the flash memory 52 of the portable player 50. The recording processing of step F152 is continued until the end of recording is determined in step F153. Consequently, the composite video signal and the analog audio signal supplied from the video output device 100 are encoded to be recorded to the portable player 50.

In step F153, the encode/control block 20 determines whether the recording is ended or not. If the record/stop key 2 is found pressed again by the user, the encode/control block 20 determines the end of recording. If the expiration of time set by the off timer is found without pressing of the record/stop key 2, the encode/control block 20 also determines the end of recording. Further, if the free space of the flash memory 52 has lowered equal to or below a predetermined level, the encode/control block 20 determines the end of recording.

If the end of recording has been determined, the encode/control block 20 ends the recording processing of step F152 and the processing goes to step F154. In step F154, the encode/control block 20 transmits a command for date and time information request to the control block 51 of the portable player 50. In response, the control block 51 of the portable player 50 reads the current date and time information counted by the clock block 58 and transmits the current date and time information to the encode/control block 20 as the processing of step F201. Receiving the current date and time information from the portable player 50, the encode/control block 20 generates time stamp data from the received current date and time information in step F155. In step F156, the encode/control block 20 executes the processing of time stamp recording to the flash memory 52. For example, the time stamp is recorded so as to be managed in a predetermined management file as corresponding to the content file recorded this time. Then, the processing of the encode/control block 20 returns to the monitor processing of step F157 or step F151.

Then, when the record/stop key 2 is pressed, the encode/control block 20 executes the processing of step F152 through step F156 again. It should be noted that, although not shown in FIG. 7, if no input signal comes from the video output device 100 when the record/stop key 2 has been pressed by the user, error handling is executed. If the detachment of the portable player 50 is detected in step F157, the encode/control block 20 ends the processing shown in FIG. 7. Subsequently, if the portable player 50 is loaded again, the encode/control block 20 starts the processing from step F151.

In the AV recorder 1, the encode/control block 20 executes the above-mentioned control processing, thereby recording the video/audio data from the video output device 100 to the flash memory 52 of the portable player 50. Also in this case, the portable player 50 functions only as a USB mass storage, so that a time stamp must be recorded on the AV recorder side. According to the processing shown in FIG. 7, the portable player 50 can get the current date and time information counted by the clock block 58 to generate time stamp data, thereby recording the generated time stamp data to the flash memory 52 of the portable player 50. Namely, a time stamp can be attached to the recorded content file.

It should be noted that, in the example shown in FIG. 7, the date and time information at the time of recording end is the time stamp data; however, it is also practicable to get the date and time information at the time of recording start and the date and time information halfway in recording from the portable player 50 to provide time stamp data indicative of the date and time and record this time stamp data to the flash memory 52 at that moment or at the end of recording.

5. Example of Delete Processing

The above-mentioned processing example I or II at the time of recording allows the AV recorder 1 to record the video/audio data outputted from the video output device 100 to the flash memory 52 of the portable player 50 as a content file and attach time stamp data thereto. The content file thus recorded to the portable player 50 may be deleted by the AV recorder 1 of the present embodiment.

In an actual type of usage, it is possible that, with the video output device 100 shown in FIG. 1 for example being a video recording/reproducing machine, recorded broadcast programs for example are recorded to the portable player 50 by use of the AV recorder 1 for listening outside home by use of the portable player 50. In such a type of usage for example, the capacity of the flash memory 52 may run short for further storage of content files if the content files already viewed remain in the flash memory 52. Therefore, it is convenient for the user to delete viewed content files from time to time.

Therefore, by executing the processing shown in FIG. 8 by the encode/control block 20, the AV recorder 1 of the present embodiment can delete content files from the portable player 50. It should be noted that FIG. 8 shows the processing that is executed while the portable player 50 is connected. For example, the decision of a delete operation of step F170 shown in FIG. 8 may be executed during the monitor loop processing in step F104 and step F109 shown in FIG. 6 (or the monitor loop processing of step F151 and step F157 shown in FIG. 7).

In step F170, the encode/control block 20 determines whether to execute a delete operation or not. If the pressing of the delete key 3 by the user is detected, the encode/control block 20 determines that a deletion operation is to be made, upon which the processing goes to step F171. In step F171, the encode/control block 20 accesses the flash memory 52 of the portable player 50 to read file management information and time stamp data corresponding to each content file.

In step F172, the encode/control block 20 determines on the basis of various conditions whether there is any content file that is subject to deletion. In this example, the processing is executed in which a content file to be deleted is not selected by the user, but the least recent file determined by the time stamp data is deleted by AV recorder 1. In this delete processing, one of the delete conditions is that the content files that can be deleted by the AV recorder 1 are limited to those which were recorded by the AV recorder 1 (or “self-recorded files” in the following), for example. For example, those content files which were transferred from other devices (a personal computer and so on) to the portable player 50 to be recorded in the flash memory 52 cannot be deleted by the AV recorder 1. Also, a condition may be provided under which a self-recorded file that has not passed a certain period of time after recording (or a minimum storage period) cannot be deleted. Further, in accordance with the current free space of the flash memory 52, the minimum storage period may be varied. For example, as the free space gets smaller, the minimum storage period may be shortened. Obviously, none of the minimum storage period conditions may be provided. In step F172, the encode/control block 20 determines by the above-mentioned conditions for example whether there is any content file that can be deleted or not. If no such content file is found, the processing comes to an end.

For example, if there is only one delete condition, that is, only a self-recorded file can be deleted, and, if there is any self-recorded file in the flash memory 52 of the portable player 50, then the processing of the encode/control block 20 goes to step F173, in which the content file of the self-recorded files that is the least recent in the recording date and time indicated by the time stamp data is selected. In step F174, the encode/control block 20 accesses the flash memory 52 to update the file system so as to delete the selected least recent content file. It should be noted that, at this moment, the encode/control block 20 makes the delete display LED 7 execute a predetermined light emitting operation. Thus, the content file delete processing is executed.

It should be noted that, in the above, the delete processing is executed in accordance with the operation of the delete key 3 by the user; however, it is also practicable to execute the delete processing automatically. For example, the free space of the flash memory 52 may run short halfway in the recording in step F105 shown in FIG. 6 or step F152 shown in FIG. 7. If this happens, it is practicable to execute the processing of steps F171 through F174 shown in FIG. 8 to delete the least recent self-recorded file for example, thereby allocating a space for further recording.

6. Effects of Embodiments and Variations

According to be above-mentioned embodiments, the AV recorder 1 can effectively use the current date and time information counting feature of the clock block 58 of the portable player 50 to from time stamp data and attaches the time stamp data to each corresponding content file to be recorded to the flash memory 52 of the portable player 50, thereby storing content files attached with time stamps. Therefore, the AV recorder 1 need not have a date and time counting feature for always counting date and time (or a realtime clock). Consequently, no user interface configuration for setting date and time counting and setting time need be disposed; for example, no operator keys and display panel for setting time for example need be disposed. Further, no internal power supply for powering always date and time counting in power-off state need be disposed. The elimination of the necessity of these realtime clock, the user interface for realtime clock time setting, and the internal battery allows a significant simplification in configuration and a significant cost cutting. Obviously, this elimination saves the user complicated operations such as time setting for example, thereby enhancing the ease of use and user convenience in using the portable player 50 as a device capable of video/audio recording.

In addition, the realization of the recording attached with time stamp data allows delete processing in which least recent self-recorded files can be deleted. The user may only press the delete key 3 to delete already viewed files to allocate a free space for new recording or viewed files are automatically deleted when the memory capacity runs short, thereby making it unnecessary for the user to select files to be deleted for user convenience. Further, the attachment of time stamp data allows the portable player 50 to display the recording date and time of each content file when displaying a list thereof and reproducing content files.

While preferred embodiments of the present invention have been described using specific terms, such description is for illustrative purpose only, and it is to be understood that changes and variations may be made without departing from the spirit or scope of the following claims. For example, various other information recording processing apparatus forms, compliant devices, compliant input signals, and encoding methods are possible. In the above-mentioned embodiments, the AV recorder 1 (the information recording processing apparatus) and the portable player 50 (the recording apparatus) are connected with each other by USB connection; however, it is also practicable to connect these apparatuses by other communication methods. For example, these apparatuses may be connected with each other by wireless communication, such as Bluetooth or infrared radiation.

In the above-mentioned embodiments, the time stamp data is the actual date and time information obtained at the end of recording for example; however, the time stamp data need not be always correct date and time information in some cases. For example, sometimes, the time stamp data may be broad date and time of recording. Also, if the time stamp data is used only for determining a least recent file in the delete processing shown in FIG. 8, the time stamp data need not be accurate recording date and time information. Namely, in this case, the time stamp data may only be the information that allows the decision of a least recent self-recorded file by providing temporal sequence information before and after each self-recorded file.

In the above-mentioned case, when the current date and time information has been obtained at the connection of the portable player 50, for example, the encode/control block 20 may store the obtained current date and time information in an internal register and add one second to the stored date and time information at file recording as time stamp data. In this case, if the value of the internal register is incremented by one second, the time stamp data of a content file to be recorded next can be generated by adding one second to the register value. Namely, if current date and time information is obtained from the portable player 50 at the time of recording, the counting operation of the time stamp counter 29 may be made unnecessary. Further, time stamp data may be generated by adding one second to the time stamp data of a most recent one of the self-recorded files recorded to the flash memory 52 to attach the generated time stamp data to a content file currently being recorded.

In the above-mentioned embodiments, the AV recorder 1 handles the portable player 50 incorporating the flash memory 52 as a USB mass storage device, thereby writing data to the flash memory 52. It is also practicable for the AV recorder 1 only to transmit data as a content file to the portable player 50 in content file recording processing. Namely, the portable player portable player 50 may record data to the flash memory 52. In this meaning, the recording apparatus cited in the claims hereof may be applied to not only the portable player 50 (a USB mass storage device) but also various other recording apparatuses for recording data to incorporated or portable recording media, thereby realizing the information recording processing apparatus according to the embodiments of the present invention as a device compatible with recording apparatuses of various types.

What is claimed is:

1. An information recording processing apparatus comprising:
connection means for communicably connecting a recording apparatus having a current date and time information counting function to said information recording processing apparatus; and
recording control means for controlling recording of an information signal by said recording apparatus connected to said information recording processing apparatus by said connection means, forming of time stamp information based on current date and time information obtained from said recording apparatus, and recording of said time stamp information by said recording apparatus as information corresponding to an information signal to be recorded by said recording apparatus.

2. The information recording processing apparatus according to claim 1, further comprising:
signal input means in which an information signal is entered, wherein
said recording control means records said information signal entered from said signal input means to said recording apparatus connected to said information recording processing apparatus by said connection means.

3. The information recording processing apparatus according to claim 2, wherein said recording control means continues counting date and time by a counter on the basis of said current date and time information obtained from said recording apparatus to form said time stamp information from a count value of said counter with a predetermined timing of controlling recording of said information signal to said recording apparatus.

4. The information recording processing apparatus according to claim 2, wherein said recording control means obtains said current date and time information from said recording apparatus with a predetermined timing of controlling recording of said information signal to said recording apparatus to form said time stamp information from the obtained current date and time information.

5. The information recording processing apparatus according to claim 2, wherein said signal input means is video input means for entering a video signal and said recording control means records to said recording apparatus said video signal entered from said video input means as said information signal.

6. The information recording processing apparatus according to claim 2, wherein said signal input means is audio input means for entering an audio signal and said recording control means records to said recording apparatus said audio signal entered from said audio input means as said information signal.

7. The information recording processing apparatus according to claim 2, further comprising:
data compression means,
wherein said recording control means records to said recording apparatus a compressed information signal compressed by said data compression means from an information signal entered from said signal input means.

8. The information recording processing apparatus according to claim 1, wherein said recording control means selects an information signal recorded to said recording apparatus that is to be deleted on the basis of said time stamp information to delete the selected information signal from said recording apparatus.

9. The information recording processing apparatus according to claim 1, wherein said connection means enables communication with a recording apparatus having a function of reproducing recorded information signal.

10. An information recording processing method comprising the steps of:
recording an information signal to a communicably connected recording apparatus having a function of counting current date and time information;
forming time stamp information on the basis of current date and time information obtained from said recording apparatus; and
recording said time stamp information to said recording apparatus as information corresponding to each recorded information signal.

11. An information recording processing apparatus comprising:
a connector configured to communicably connect a recording apparatus having a current date and time information counting function to said information recording processing apparatus; and
a recording controller configured to control recording of an information signal by said recording apparatus connected to said information recording processing apparatus by said connector, forming of time stamp information based on current date and time information obtained from said recording apparatus, and recording of said time stamp information by said recording apparatus as information corresponding to an information signal to be recorded by said recording apparatus.
